(19) United States
(12) Patent Application Publication
(10) Pub. No.: US 2023/0093614 A1
(43) Pub. Date: Mar. 23, 2023

(54) ITEM IDENTIFICATION METHOD AND APPARATUS, DEVICE, AND COMPUTER-READABLE STORAGE MEDIUM

(71) Applicant: SENSETIME INTERNATIONAL PTE. LTD., Singapore (SG)

(72) Inventor: Daming NIU, Singapore (SG)

(21) Appl. No.: 17/489,160

(22) Filed: Sep. 29, 2021

Related U.S. Application Data
(63) Continuation of application No. PCT/IB2021/058775, filed on Sep. 27, 2021.

(30) Foreign Application Priority Data
Sep. 22, 2021 (SG) 102021 10505W

(51) Int. Cl. G06K 9/62; G06F 16/901; H04W 4/80

(52) U.S. Cl. CPC G06K 9/6212; G06K 9/6223; G06K 9/6262; G06K 9/6292; G06F 16/9024; H04W 4/80

(57) ABSTRACT

Provided are an item identification method and apparatus, a device, and a computer-readable storage medium. The method includes: categories of items contained in a group of to-be-identified items and quantity information of items in each category contained in the group of to-be-identified items are determined by performing short-range wireless communication with each item in a group of to-be-identified items in a scenario region, each item containing a short-range wireless communication tag corresponding to a category of each item; acquired images of the group of to-be-identified items are identified to obtain an image identification result of the group of to-be-identified items, the image identification result including a category identification result of each item in the group of to-be-identified items; and an item identification result of the group of to-be-identified items is determined based on the quantity information and the image identification result.

### CROSS-REFERENCE TO RELATED APPLICATION(S)

The application is continuation of international application PCT/IB2021/058775 filed on 27 Sep. 2021, which claims priority to Singapore patent application No. 10202110505W filed with IPOS on 22 Sep. 2021. The contents of international application PCT/IB2021/058775 and Singaporean patent application No. 10202110505W are incorporated herein by reference in their entireties.

### TECHNICAL FIELD

The disclosure relates to image processing technologies, and particularly to an item identification method and apparatus, a device, and a computer-readable storage medium.

### BACKGROUND

Image identification has been widely applied to various fields such as robots and autopilot. Short-range wireless communication, such as radio frequency identification technology, is mainly applied to fields such as access control, smart shelves, and the Internet of Things. Both of the image recognition and the short-distance wireless communication have certain defects in the process of intelligent identification on items.

### SUMMARY

Embodiments of the disclosure provide an item identification method and apparatus, a device, and a computer-readable storage medium, which can improve accuracy and coverage of an identification result.

The embodiments of the disclosure provide an item identification method, which may include: categories of items contained in a group of to-be-identified items and quantity information of items in each category contained in the group of to-be-identified items are determined by performing short-range wireless communication with each item in a group of to-be-identified items in a scenario region, each item containing a short-range wireless communication tag corresponding to a category of each item; acquired images of the group of to-be-identified items are identified to obtain an image identification result of the group of to-be-identified items, the image identification result including a category identification result of each item in the group of to-be-identified items; and an item identification result of the group of to-be-identified items is determined based on the quantity information and the image identification result.

In the above method, the operation that categories of items contained in a group of to-be-identified items and quantity information of items in each category contained in the group of to-be-identified items are determined by performing short-range wireless communication with each item in a group of to-be-identified items in a scenario region may include: short-range wireless communication is performed with a second communication component of each to-be-identified item in the group of to-be-identified items in the scenario region by using a first communication component pre-erected in the scenario region to obtain an item identifier stored in the second communication component of each item; and the categories of the items contained in the group of to-be-identified and the quantity information of the items in each category contained in the group of to-be-identified items are determined based on the item identifier and a prestored preset correspondence between item identifiers and item categories.

In the above method, the operation that an item identification result of the group of to-be-identified items is determined based on the quantity information and the image identification result may include: a to-be-matched image identification result and a matched image identification result are determined from the image identification result of the group of to-be-identified items based on the image identification result and a preset confidence threshold; quantity information of matched items of the items in each category is determined according to the matched image identification result; quantity information of to-be-matched items in each category is determined based on the quantity information of the matched items and the quantity information of the items in each category; matching check is performed according to the quantity information of the to-be-matched items in each category and the to-be-matched image identification result, to determine a secondary identification result; and the item identification result is determined according to the matched image identification result and the secondary identification result.

In the above method, the category identification result of each item may include a probability of each item belonging to each of k categories, k being an integer greater than or equal to 1; the matched image identification result includes a category identification result of matched items in the group of to-be-identified items, the matched items including an item with a maximum probability, among k probabilities, greater than the preset confidence threshold; and the to-be-matched image identification result includes a category identification result of to-be-matched items in the group of to-be-identified items, the to-be-matched items including an item with a maximum probability, among k probabilities, less than the preset confidence threshold.

In the above method, the operation that matching check is performed according to the quantity information of the to-be-matched items in each category and the to-be-matched image identification result, to determine a secondary identification result may include: an item element set of each category is constructed, total quantity information of item elements in the item element set referring to quantity information of the to-be-matched items in a corresponding category; a candidate category of each to-be-matched item is determined according to the probability of each item belonging to each of k categories; a weighted bipartite graph is constructed for each to-be-matched item, where the to-be-matched item is taken as a first node and each item element in the item element set of each candidate category is taken as a second node in the weighted bipartite graph, a probability of the candidate category corresponding to each second node is a weight corresponding to an edge connecting the first node to each second node, and the candidate category corresponding to each second node is a category corresponding to an item element set to which the item element represented by each second node belongs; and maximum bipartite graph matching is performed based on the weighted bipartite graph, to obtain a category of each to-be-matched item as the secondary identification result.

In the above method, the operation that matching check is performed according to the quantity information of the to-be-matched items in each category and the to-be-matched image identification result, to determine a secondary identification result may include: for each to-be-matched item, in the case where a result of the maximum bipartite graph matching performed based on the weighted bipartite graph is that none of the to-be-matched items is successfully matched with each of the item elements, a candidate category with the maximum probability of the to-be-matched item is taken as the secondary identification result of the to-be-matched item.

In the above method, the operation that the item identification result is determined according to the matched image identification result and the secondary identification result may include: the category identification result of the matched items in the matched image identification result is fused with the secondary identification result of the to-be-matched items to obtain the item identification result.

The embodiments of the disclosure provide an item identification apparatus, which may include: a communication unit, configured to determine categories of items contained in a group of to-be-identified items and quantity information of items in each category contained in the group of to-be-identified items by performing short-range wireless communication with each item in the group of to-be-identified items in a scenario region, each item containing a short-range wireless communication tag corresponding to a category of each item; an identification unit, configured to identify acquired images of the group of to-be-identified items to obtain an image identification result of the group of to-be-identified items, the image identification result including a category identification result of each item in the group of to-be-identified items; and a determination unit, configured to determine an item identification result of the group of to-be-identified items based on the quantity information and the image identification result.

In the above apparatus, the communication unit is further configured to: perform, by using a first communication component pre-erected in the scenario region, short-range wireless communication with a second communication component of each to-be-identified item in the group of to-be-identified items in the scenario region to obtain an item identifier stored in the second communication component of each item; and determine, based on the item identifier and a prestored preset correspondence between item identifiers and item categories, the categories of the items contained in the group of to-be-identified and quantity information of the items in each category contained in the group of to-be-identified items.

In the above apparatus, the determination unit is further configured to: determine a to-be-matched image identification result and a matched image identification result from the image identification result of the group of to-be-identified items based on the image identification result and a preset confidence threshold; determine quantity information of matched items of the items in each category according to the matched image identification result; determine quantity information of to-be-matched items in each category based on the quantity information of the matched items and the quantity information of the items in each category; perform matching check according to the quantity information of the to-be-matched items in each category and the to-be-matched image identification result, to determine a secondary identification result; and determine the item identification result according to the matched image identification result and the secondary identification result.

In the above apparatus, the category identification result of each item may include a probability of each item belonging to each of k categories, k being an integer greater than or equal to 1; the matched image identification result includes the category identification result of matched items in the group of to-be-identified items, the matched items including an item with a maximum probability, among k probabilities, greater than the preset confidence threshold; and the to-be-matched image identification result includes the category identification result of to-be-matched items in the group of to-be-identified items, the to-be-matched items including an item with a maximum probability, among k probabilities, less than the preset confidence threshold.

In the above apparatus, the determination unit is further configured to: construct an item element set of each category, total quantity information of item elements in the item element set referring to the quantity information of the to-be-matched items in a corresponding category; determine a candidate category of each to-be-matched item according to the probability of each item belonging to each of k categories; construct a weighted bipartite graph for each to-be-matched item, where the to-be-matched item is taken as a first node and each item element in the item element set of each candidate category is taken as a second node in the weighted bipartite graph, a probability of the candidate category corresponding to each second node is a weight corresponding to an edge connecting the first node to each second node, and the candidate category corresponding to each second node is a category corresponding to an item element set to which the item element represented by each second node belongs; and perform maximum bipartite graph matching based on the weighted bipartite graph, to obtain a category of each to-be-matched item as the secondary identification result.

In the above apparatus, the determination unit is further configured to, for each to-be-matched item, in the case where a result of the maximum bipartite graph matching performed based on the weighted bipartite graph is that none of the to-be-matched items is successfully matched with each of the item elements, take a candidate category with the maximum probability of the to-be-matched item as the secondary identification result of the to-be-matched item.

In the above apparatus, the determination unit is further configured to fuse the category identification result of the matched items in the matched image identification result with the secondary identification result of the to-be-matched items to obtain the item identification result.

The embodiments of the disclosure provide an electronic device, which may include a memory and a processor. The memory is configured to store an executable computer program. The processor is configured to implement the above item identification method when executing the executable computer program stored in the memory.

The embodiments of the disclosure provide a computer-readable storage medium, storing a computer program, which is executed by a processor to implement the above item identification method.

The embodiments of the disclosure provide the item identification method and apparatus, the device, and the computer-readable storage medium. By performing short-range wireless communication with each item in a group of to-be-identified items in a scenario region, categories of the items contained in the group of to-be-identified items and quantity information of the items in each category contained in the group of to-be-identified items are determined, each item containing a short-range wireless communication tag corresponding to the category of the item; acquired images of the group of to-be-identified items are identified to obtain an image identification result, the image identification result including a category identification result of each item in the group of to-be-identified items. The item identification result of the group of to-be-identified items is determined based on the combination of the quantity information and the image identification result. Therefore, compared with an image recognition result or a short-range wireless communication identification result, the identification result acquired finally is more accurate, more comprehensive, and covers more information, and thus the accuracy and coverage of the identification result are improved.

It is to be understood that the above general descriptions and detailed descriptions below are only exemplary and explanatory and not intended to limit the present disclosure.

### BRIEF DESCRIPTION OF THE DRAWINGS

FIG. 1 is a flowchart of an item identification method according to an embodiment of the disclosure.

FIG. 2 is a flowchart of an item identification method according to an embodiment of the disclosure.

FIG. 3A is a schematic diagram of an exemplary game scenario according to an embodiment of the disclosure.

FIG. 3B is a schematic diagram of a game region on a game table exemplarily shown in FIG. 3A according to an embodiment of the disclosure.

FIG. 4 is a flowchart of an item identification method according to an embodiment of the disclosure.

FIG. 5 is a schematic diagram of exemplary three bets of game tokens in a preset posture according to an embodiment of the disclosure.

FIG. 6 is a schematic diagram of a process of obtaining a quantity identification result of a group of to-be-identified items, region information of each item, a category identification result, and a position identification result through image identification, according to an embodiment of the present disclosure.

FIG. 7 is a flowchart of an item identification method according to an embodiment of the disclosure.

FIG. 8 is a flowchart of an item identification method according to an embodiment of the disclosure.

FIG. 9 is a schematic diagram of exemplary construction of weighted edges between a sub-image identification result i and three items according to an embodiment of the disclosure.

FIG. 10 is a flowchart of an item identification method according to an embodiment of the disclosure.

FIG. 11 is a structure diagram of an item identification apparatus according to an embodiment of the disclosure.

FIG. 12 is a structure diagram of an electronic device according to an embodiment of the disclosure.

### DETAILED DESCRIPTION

The described embodiments should not be considered as limits to the disclosure. All other embodiments obtained by those of ordinary skill in the art without creative work shall fall within the scope of protection of the disclosure.

Before the embodiments of the disclosure are further described in detail, nouns and terms involved in the embodiments of the disclosure will be described. The nouns and terms involved in the embodiments of the disclosure are suitable for the following explanations.

1) Radio Frequency Identification technology (RFID for short): Its principle is to perform non-contact data communication between a reader and a tag to achieve the purpose of identifying a target. RFID has a wide range of applications. Typical applications include animal chips, car chip anti-theft devices, access control, parking lot control, production line automation, and material management.

2) Bluetooth (BT for short): A BT technology is an open global specification for wireless data and voice communication, which is a special short-range wireless-technology connection for establishing a communication environment for fixed and mobile devices, based on low-cost short-range wireless connection.

3) Near Field Communication technology (NFC for short): It is an emerging technology, and devices using the NFC technology (such as mobile phones) may perform data exchange when they are close to each other.

4) Identity Document Number is called ID for short.

The embodiments of the disclosure provide an item identification method, which can improve accuracy of an identification result. According to the embodiments of the disclosure, the item identification method is applied to an electronic device. The electronic device provided in the embodiments of the disclosure may be implemented as various types of user terminals (short for terminals below) such as Augmented Reality (AR) glasses, a notebook computer, a tablet computer, a desktop computer, a set-top box, and a mobile device (for example, a mobile phone, a portable music player, a personal digital assistant, a dedicated messaging device, and a portable game device), and may also be implemented as a server.

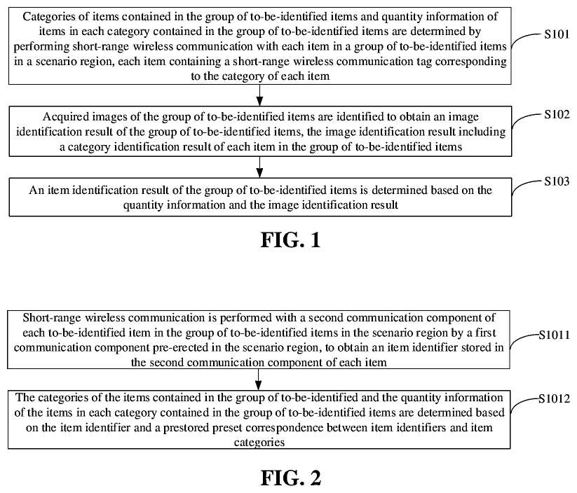

FIG. 1 is a flowchart of an item identification method according to an embodiment of the disclosure, which will be described with reference to the steps shown in FIG. 1.

In S101, categories of items contained in the group of to-be-identified items and quantity information of items in each category contained in the group of to-be-identified items are determined by performing short-range wireless communication with each item in a group of to-be-identified items in a scenario region, each item containing a short-range wireless communication tag corresponding to the category of each item.

In the embodiment of the disclosure, the terminal may adopt the RFID, BT, or NFC technology to perform short-range wireless communication with the short-range wireless communication tag contained in each to-be-identified item (“item” for short) and corresponding to the category of the item in a group of to-be-identified items in a certain scenario region, so as to determine an item category (“category” for short) of each item in the group of to-be-identified items, thereby determining the quantity of items in each category. Exemplarily, the short-range wireless communication tag of an item may be an electronic tag for identifying the item or for identifying the category of the item, and may be contained in the item.

In the embodiment of the disclosure, a group of to-be-identified items may include at least one item, may also include two or more items. The one or two or more items in the group of to-be-identified items may be in a dispersed and spread state, or in a state being stacked into a stack or object sequence, or the like, which is not limited in the embodiment of the disclosure. Multiple groups of to-be-identified items may be provided in the scenario region. The embodiment of the disclosure describes each group of to-be-identified items.

In the embodiment of the disclosure, the to-be-identified items may be any items, for example, may be game tokens, packages, goods on shelves, which is not limited in the embodiment of the disclosure.

In some embodiments, in case where the to-be-identified items refer to game tokens, the scenario region may be a game token placement region on a game table; in case where the to-be-identified items refers to goods on shelves, the scenario region may be a shelf region in a warehouse, or a good display region in a certain store, or the like. Limitation on the scenario region is omitted in the embodiment of disclosure. Hereinafter, the embodiment of the disclosure will be described by taking the to-be-identified items as the game tokens and the scenario region as the game token placement region on the game table as an example.

In S102, acquired images of the group of to-be-identified items are identified to obtain an image identification result of the group of to-be-identified items, the image identification result including a category identification result of each item in the group of to-be-identified items.

In the embodiment of the disclosure, the terminal may adopt a pre-trained model (for example, a deep learning model) to identify the acquired images of the group of to-be-identified items to obtain the image identification result of the group of to-be-identified items, and the image identification result may include the category identification result of each item in the group of to-be-identified items.

In some embodiments of the disclosure, the image identification result corresponding to the group of to-be-identified items includes at least one sub-image identification result, and each sub-image identification result may include: an image region corresponding to an identified item, a probability of the item belonging to each category (i.e., the above category identification result), and a position identification result of the image region (i.e., a sort order of the image region).

In some embodiments, the images of the group of to-be-identified items may be obtained by a terminal through an acquisition apparatus, for example, a camera, which takes pictures of the group of to-be-identified items. In some other embodiments, the images of the group of to-be-identified items may be acquired through other devices and then obtained by the terminal from the other devices. Limitations are omitted in the embodiment of the disclosure.

In S103, an item identification result of the group of to-be-identified items is determined based on the quantity information and the image identification result.

In the embodiment of the disclosure, after obtaining the quantity of items in each category in the group of to-be-identified items and the category identification result of each item, the terminal may determine the final item identification result of the group of to-be-identified items, for example, the quantity of items in each category in the group of to-be-identified items and the total quantity of the items in the group of to-be-identified items.

In some embodiments of the disclosure, the image identification result corresponding to the group of to-be-identified items include at least one sub-image identification result, and each sub-image identification result may include: an image region corresponding to an identified item, a probability of the item belonging to each category (i.e., the above category identification result), and a position identification result of the image region (i.e., a sort order of the image region); and when the image identification result corresponding to the group of to-be-identified items further includes the quantity of image regions (i.e., the quantity of corresponding items, and each image region is an region of an item), after obtaining the quantity of items in each category in the group of to-be-identified items, the image identification result that includes information such as the image region corresponding to each identified item, the probability of each item belonging to each category, the position identification result of each image region, and the quantity of the image regions (i.e., the quantity of the corresponding items), the terminal may determine the item identification result such as the total quantity of the all the items in the group of to-be-identified items, and positions of items in each category in the group of to-be-identified items (for example, which position the item in each category is placed in among the group of to-be-identified items).

In some embodiments of the disclosure, the terminal may record status of the scenario to which it belongs in real time according to the item identification result of the group of to-be-identified items. For example, in case where the to-be-identified items refer to game tokens and the scenario region is a game token placement region on a game table, after obtaining the quantity of game tokens of each face value (for example, 50 and 100) in a stack of game tokens and the image identification result of each game token, the terminal may determine the final quantity of game tokens of each face value in the stack of game tokens and the position of each game token in the stake of game tokens, and further record the total face values of the game tokens placed in the game placement region by a player, game modes of the player, and the like in real time according to the finally determined quantity of game tokens of each face value in the stack of game tokens and position of each game token in the stack of game tokens.

In the embodiment of the disclosure, by performing short-range wireless communication with each item in a group of to-be-identified items in a scenario region, categories of the items contained in the group of to-be-identified items and quantity information of the items in each category contained in the group of to-be-identified items are determined; acquired images of the group of to-be-identified items are identified to obtain an image identification result of the group of to-be-identified items, the image identification result including a category identification result of each item in the group of to-be-identified items; and an item identification result of the group of to-be-identified items is determined based on the quantity information and the image identification result; accordingly, compared with an image recognition result or a short-range wireless communication identification result, the identification result acquired finally is more accurate, more comprehensive, and covers more information, and thus the accuracy and coverage of the identification result are improved.

In the embodiment of the disclosure, since the obtained item identification result of the group of to-be-identified items is more accurate and comprehensive, the scenario status recorded based on the accurate and comprehensive identification result is more accurate and covers more information.

In some embodiments of the disclosure, the above S101 may be implemented through S1011 to S1012, which will be described with reference to the steps shown in FIG. 2.

In S1011, short-range wireless communication is performed with a second communication component of each to-be-identified item in the group of to-be-identified items in the scenario region by a first communication component pre-erected in the scenario region, to obtain an item identifier stored in the second communication component of each item.

In the embodiment of the disclosure, the terminal may adopt the first communication component pre-erected in the scenario region to perform short-range wireless communication with the second communication component of each to-be-identified item in the group of to-be-identified items in the scenario region, in a mode of short-range wireless communication, so as to obtain an item identifier stored in the second communication component of each item, here different items correspond to different item identifiers. It is to be noted that, the second communication component may be a short-range wireless communication tag corresponding to the category corresponding to each item.

Exemplarily, in the case where the first communication component is an RFID detection antenna, the second communication component may be an RFID chip, and the RFID detection antenna reads information in the RFID chip to obtain the item identifier; in the case where the first communication component is a BT device, the second communication component may also be a BT device, and Bluetooth communication is performed between every two BT devices through a BT pairing connection so as to acquire the item identifier; and, in the case where the first communication component is an NFC card reader, the second communication component may be an NFC chip, and the NFC card reader reads information in the NFC chip to obtain the item identifier.

In the embodiment of the disclosure, the first communication component may be pre-erected in the scenario region, and the first communication component is configured to be communicated with the second communication component in a certain designated sub-region in the scenario region; moreover, each item may be provided with a second communication component, and when an item is placed in the scenario region or enters the scenario region, the short-range wireless communication between the first communication component and the second communication component on the item is triggered.

In some embodiments, the item identifier of the second communication component may be an ID of the second communication component, for example, when the second communication component is an RFID chip, the item identifier may be an ID of the RFID, and IDs of the RFID chips corresponding to different items may be different.

In S1012, the categories of the items contained in the group of to-be-identified and the quantity information of the items in each category contained in the group of to-be-identified items are determined based on the item identifier and a prestored preset correspondence between item identifiers and item categories.

In the embodiment of the disclosure, when the terminal performs short-range wireless communication with each item to obtain the item identifier of each item, for each item identifier, the terminal may query the prestored preset correspondence between item identifiers and item categories according to the item identifier to obtain the category of the item corresponding to the item identifier. Moreover, the terminal further calculates the total quantity of the item identifiers of each category so as to acquire the quantity information of the items in each category in the group of to-be-identified items.

In some embodiments, in the preset correspondence between item identifiers and item categories, a certain type of item identifier may correspond to one item category, for example, when the item identifier is a letter, it corresponds to item category A, and when the item identifier is a number, it corresponds to item category B. In some other embodiments, an item identifier within a certain numerical range may correspond to one item category, for example, when the item identifier belongs to the numerical range [0, 30], it corresponds to the item category A. The preset correspondence between identifiers and item categories is not limited in the embodiment of the disclosure.

In some embodiments, by setting the first communication component as an RFID detection antenna and setting the second communication component as an RFID chip, the terminal may quickly and accurately obtain the quantity of items in each category in each group of to-be-identified items through the RFID technology.

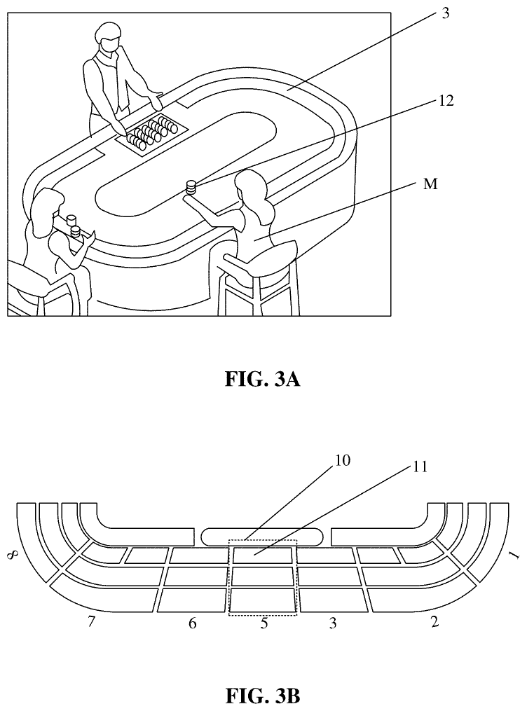

Exemplarily, for the above S1011 to S1012, FIG. 3A is a schematic diagram of an exemplary game scenario according to an embodiment of the disclosure. FIG. 3B is a schematic diagram of a game region on a game table exemplarily shown in FIG. 3A according to an embodiment of the disclosure.

In the game scenario, it can be seen from both FIG. 3A and FIG. 3B that the scenario region is a game token placement region 11 on a game table 3. As shown in FIG. 3B, game regions corresponding to eight players are shown, and a game region 10 of each player includes a game token placement region 11. As shown in FIG. 3A, a group of to-be-identified items refers to a bet of game tokens 12 in the game token placement region 11 (not shown in FIG. 3A). The first communication component is an RFID detection antenna (not shown in FIG. 3A and FIG. 3B) preset in the game token placement region 11, and the second communication component is an RFID chip (not shown in FIG. 3A and FIG. 3B) built in each game token. As shown in FIG. 3A, when player M places a bet of game tokens 12 in the game token placement region 11, the terminal reads an ID of the RFID chip in each game token through the RFID detection antenna to obtains the face value of each game token according to the ID and a prestored preset correspondence between IDs and game token face values, and calculates the quantity of the game tokens of each face value among the bet of game tokens.

In some embodiments of the disclosure, the above S102 may be implemented through S1021 to S1025, which will be described with reference to FIG. 4.

In S1021, acquired images of a group of to-be-identified items are identified to determine region information of each item.

In S1022, the items corresponding to each region information are classified by means of an image classification model, based on the region information of each item, to obtain a category identification result of each item.

In the embodiment of the disclosure, the terminal may adopt the pre-trained image identification model to identify the acquired images of a group of to-be-identified items to obtain the image region (i.e., region information) of each identified item, and adopts the pre-trained image classification model to classify items corresponding to each region information to obtain the probability of each item belonging to each category. The probability of each item belonging to each category is taken as the category identification result of the item.

In S1023, a position identification result of each item is determined based on a sort order of the region information of each item.

In S1024, a quantity identification result of the group of to-be-identified items is determined based on the quantity of the region information of each item.

In the embodiment of the disclosure, for an image of a group of to-be-identified items, the terminal may determine the position identification result of the item corresponding to each region information according to the sort order of each region information when obtaining all the region information in the image. For example, when the sort order of one region information is 3, the position identification result of the item corresponding to the region information is that it is the third one in the group of to-be-identified items. The terminal may also count the quantity of the region information of the image to obtain the quantity of identified items in the group of to-be-identified items, and takes the quantity of the items as the quantity identification result of the group of to-be-identified items.

In S1025, the quantity of identification result of the group of to-be-identified items, the category identification result of each item, and the position identification result of each item are taken as an image identification result of the group of to-be-identified items.

In the embodiment of the disclosure, when obtaining the quantity of identification result of a group of to-be-identified items, the category identification result of each item, and the position identification result of each item, the terminal may take the quantity identification result, and the category identification result and position identification result of each item as the image identification result of the group of to-be-identified items.

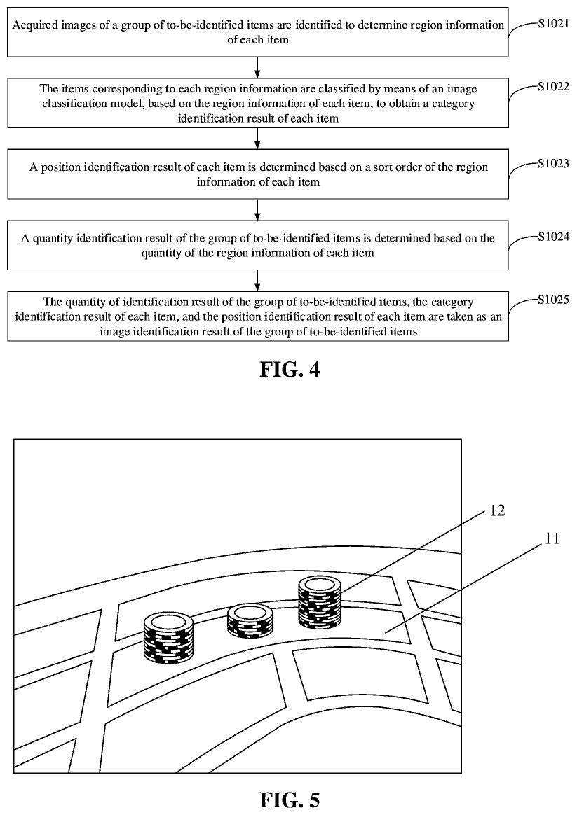

In some embodiments, before image identification is performed on a group of to-be-identified images, posture identification may be performed on images of the group of to-be-identified items first to determine whether the posture of the group of to-be-identified items is a preset posture. When the posture of the group of to-be-identified items is the preset posture, image identification is performed on the group of to-be-identified items, to obtain the corresponding image identification result. It is to be noted that the preset posture may be set according to actual requirements, for example, may be in a stacked state, may also be in a horizontal state, which is not limited in the embodiment of the disclosure. For example, FIG. 5 shows three stacks of game tokens in the preset posture in the case where the to-be-identified items refer to game tokens. As shown in FIG. 5, for each bet 12 of the three stacks of game tokens placed in a game token placement region 11, the terminal may determine that the stack of game tokens is in a preset posture when identifying that the stack of game tokens is in a sideward posture, and perform image identification on the stack of game tokens.

Exemplarily, FIG. 6 is a schematic diagram of a process of obtaining a quantity identification result of a group of to-be-identified items, region information of each item, a category identification result, and a position identification result through image identification, according to an embodiment of the present disclosure. As shown in FIG. 6, in the case where the group of to-be-identified items refers to a bet of game tokens, the terminal may perform edge detection on an image I of the bet of game tokens first through an image identification module, and perform image segmentation on the image I according to an edge detection result to obtain region information corresponding to each identified game token. Moreover, the sort order of the region information corresponding to each game token is the position identification result of the game token. For example, region information Y1 in FIG. 6 is arranged at the second position up to down, then the position identification result of the game token corresponding to the region information Y1 is that it is the second one among the stack of game tokens up to down. After the region information of each identified game token is obtained, the terminal continues to classify each region information through the image classification model, to determine a probability (not shown in FIG. 6) that the game token corresponding to each region information belongs to each face value, so as to obtain the category identification result of the game token corresponding to each region information.

According to the embodiment of the disclosure, the terminal may accurately identify the position of each identified item in the group of to-be-identified items.

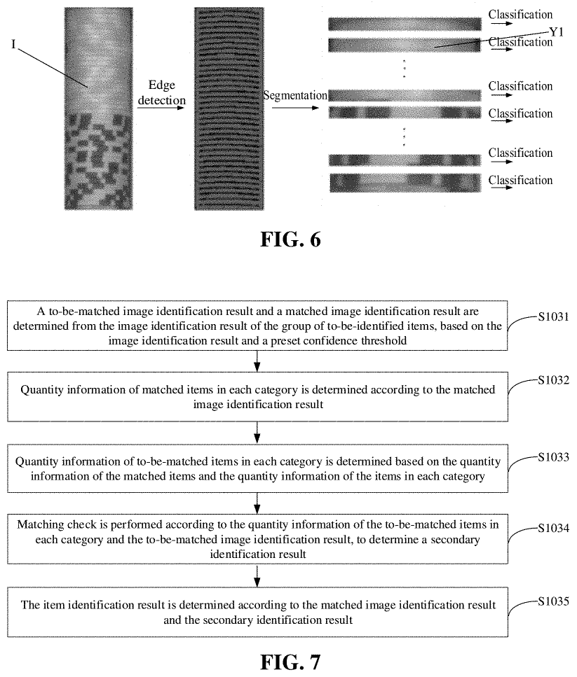

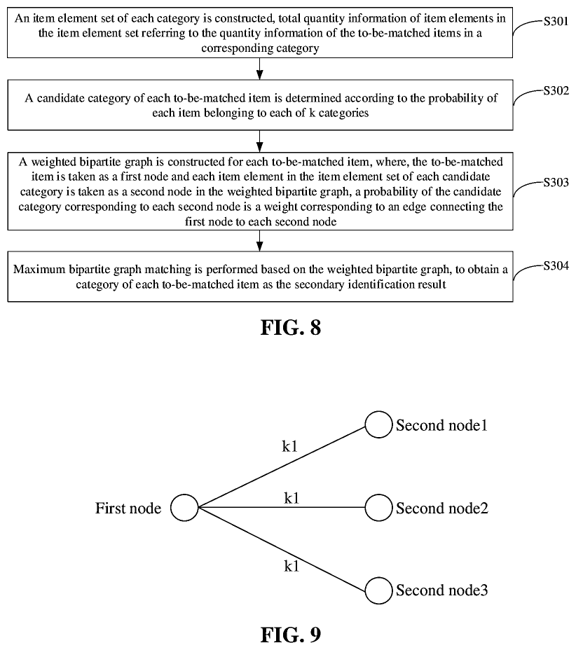

In some embodiments of the disclosure, the above S103 may be implemented through S1031 to S1035, which will be described with reference to the steps shown in FIG. 7.

In S1031, a to-be-matched image identification result and a matched image identification result are determined from the image identification result of the group of to-be-identified items, based on the image identification result and a preset confidence threshold.

In the embodiment of the disclosure, when the image identification result of the group of to-be-identified items is obtained, the terminal may determine the to-be-matched image identification result and the matched image identification result from the image identification result of the group of to-be-identified items, according to a preset confidence threshold.

In some embodiments, the category identification result of each item may include: a probability of the item belonging to each of k categories, k being an integer greater than or equal to 1; the matched image identification result includes: a category identification result of the matched items in the group of to-be-identified items, the matched items including an item with a maximum probability, among k probabilities, greater than the preset confidence threshold.

In some embodiments, the to-be-matched image identification result includes: a category identification result of the to-be-matched items in the group of to-be-identified items, the to-be-matched items including an item with a maximum probability, among k probabilities, less than the preset confidence threshold.

Here, K may be set according to actual requirements, and its value is not limited in the embodiment of the disclosure.

In some embodiments of the disclosure, the image identification result includes at least one sub-image identification result. Each sub-image identification result corresponds to one item. The sub-image identification result includes the probability of the item belonging to each of k categories (i.e., k probabilities). The terminal may determine whether the sub-image identification result is the to-be-matched image identification result or the matched image according to the relationship of size between the maximum probability of the k probabilities of the item corresponding to each sub-image identification result and the preset confidence threshold. For a sub-image identification result, in the case where the maximum probability among the k probabilities of the item corresponding to the sub-image identification result is less than or equal to the preset confidence threshold, the sub-image identification result is the to-be-matched image identification result; in the case where the maximum probability among the k probabilities of the item corresponding to the sub-image identification result is greater than the preset reliability threshold, the sub-image identification result is the matched image identification result. For example, a sub-image identification result corresponds to item a, and item a corresponds to 3 probabilities: PA, the probability of belonging to category A; PB, the probability of belonging to category B; and PC, the probability of belonging to category C, where the value of PC is the largest; thus, when PC is greater than a preset confidence threshold t, the sub-image identification result corresponding to the item a is the matched image identification result; when PC is less than or equal to the preset confidence threshold, the sub-image identification result corresponding to the item a is the to-be-matched image identification result. The sum of quantities of all the to-be-matched image identification results of all the matched image identification results is the same as the total quantity of sub-image identification results contained in the image identification result of the group of to-be-identified items.

It is to be noted that in some other embodiments, the quantity of the to-be-matched image identification result may be 0. When none of the sub-image identification results in the image identification result of the group of to-be-identified items belongs to the to-be-matched image identification result, it means that all the sub-image identification results are credible, and the subsequent secondary identification step is omitted, and moreover, the image identification result may be directly used as the item identification result. In the embodiment of the disclosure, the description is mainly focused on that the quantity of the to-be-matched image identification result is greater than 0.

According to the embodiment of the disclosure, the preset confidence threshold is used to determine the to-be-identified image identification result and the matched image identification result, improving the accuracy in checking the image recognition result.

In S1032, quantity information of matched items in each category is determined according to the matched image identification result.

In the embodiment of the disclosure, for a group of to-be-identified items, after obtaining all the matched image identification results of the group of to-be-identified items, the terminal may determine the category of each matched item according to the maximum probability of k probabilities of the matched item corresponding to each matched image identification result, so as to obtain the categories of all the matched items corresponding to all the matched image identification results; in addition, after obtaining the categories of all the matched items, the terminal may classify each matched item to determine quantity information of the matched items in each category.

In S1033, quantity information of to-be-matched items in each category is determined based on the quantity information of the matched items and the quantity information of the items in each category.

In the embodiment of the disclosure, for a group of to-be-identified items, after obtaining the quantity information of the matched items in each category, according to the quantity information of the items in each category determined through short-range wireless communication, the terminal may obtain the quantity information of the to-be-matched items in each category.

It can be understood that, in the embodiment of the disclosure, for a group of to-be-identified items, the quantity information of items in each category in the group of to-be-identified items may be accurately determined through short-range wireless communication. Since the accuracy of image identification is not as high as that of short-range wireless communication, the quantity of items in each category determined based on the matched image identification result is likely to be less than the quantity of items in each category obtained through short-range wireless communication. By comparing the quantity of items in each category determined based on the matched image identification result with the quantity of items in each category determined through short-distance wireless communication, the quantity of items in each category that is not accurately identified through image identification may be determined. The quantity of the items is the quantity of the to-be-matched items in each category.

Here, for each category of items, the terminal may subtract the second quantity which is represented by the quantity information of the matched items in the category that is determined according to the matched image identification result from the first quantity which is represented by the quantity information of the items in the category that is determined in a short-range wireless communication mode, to obtain the quantity information of the to-be-matched items in the category. For example, according to the matched image identification result, the terminal determines that the quantity of matched items belonging to category A is 1, the quantity of matched items belonging to category B is 3, and the quantity of matched items belonging to category C is 2, and by the short-range wireless communication mode, the terminal previously determines that the quantity of items in category A is 3, the quantity of items in category B is 4, and the quantity of items in category B is 2; then the terminal may subtract the quantity, i.e., 1, of the matched items belonging to category A from the obtained quantity, i.e., 3, of the items in category A, and use the quantity, i.e., 2, of the remaining items belonging to category A as the quantity of the to-be-matched items in category A, that is 2; and may subtract the quantity, i.e., 3, of the matched items belonging to category B from the obtained quantity, i.e., 4, of the items in category B, and use the number 1 of the remaining item belonging to category B as the quantity of the to-be-matched items in category B, that is 1; and may subtract the quantity, i.e., 2, of the matched items belonging to category B from the obtained quantity, i.e., 2, of the items in category B, to obtain the quantity, i.e., 0; due to the result of 0, it is determined that the quantity of the to-be-matched item in category C is 0, indicating that there is no to-be-matched items in category C.

In S1034, matching check is performed according to the quantity information of the to-be-matched items in each category and the to-be-matched image identification result, to determine a secondary identification result.

In the embodiment of the disclosure, after obtaining the quantity information of the to-be-matched items in each category and all the to-be-matched image identification results, the terminal may perform matching check on the quantity information of the to-be-matched items in each category and the corresponding category, thereby determining the category of the to-be-matched item corresponding to each to-be-matched image identification result, and taking the category of the to-be-matched item corresponding to each to-be-matched image identification result as the secondary identification result of the corresponding to-be-matched item. It is to be noted that the total quantity of the to-be-matched items is the same as the total quantity of the to-be-matched image identification results.

In S1035, the item identification result is determined according to the matched image identification result and the secondary identification result.

In the embodiment of the present disclosure, for a group of to-be-identified items, after obtaining the secondary identification result of the to-be-matched item corresponding to each to-be-matched image identification result, the terminal may obtain the item identification result of the group of to-be-identified items according to the identification results of all the matched images and the secondary identification results of all the to-be-matched items.

In some embodiments, the terminal may fuse the category identification result of the matched items in the matched image identification result with the secondary identification result of the to-be-matched items to obtain the item identification result.

It can be understood that the terminal may take both the category identification results of the matched items corresponding to all the matched image identification results and the secondary identification results of all the to-be-matched items as the item identification result.

In some embodiments of the disclosure, the above S1034 may be implemented through S301 to S304, which will be described with reference to FIG. 8.

In S301, an item element set of each category is constructed, total quantity information of item elements in the item element set referring to the quantity information of the to-be-matched items in a corresponding category. That is, the item elements in the item element set are in one-to-one correspondence with the to-be-matched items in the corresponding category.

In the embodiment of the disclosure, for the to-be-matched items in each category, the terminal may determine the quantity information of the to-be-matched items in each category according to the above S1033 to construct an item element set of each category, the total quantity of item elements in the item element set is equal to the quantity information of the to-be-matched items in the category, and each item element corresponds to a to-be-matched item. The category of the to-be-matched item is determined in a short-range wireless communication mode. For example, the item category refers to a game token face value, the items are game tokens, and the short-range wireless communication mode refers to an RFID mode, for each game token face value, the terminal may subtract the quantity of matched game tokens of the face value obtained in S1033 from the quantity of game tokens of the face value obtained in the above S101 to obtain the quantity of game tokens of which the face value is identified in the RFID mode, remained in the game tokens of the face value, and the quantity of remaining game token of which the face value is identified in the RFID mode (the quantity of to-be-matched game tokens in the category), and take the remaining game tokens of which the face value is identified in the RFID mode as an item element set of the face value. Each item element in the item element set refers to one remaining game token of which the face value is identified in the RFID mode.

In S302, a candidate category of each to-be-matched item is determined according to the probability of each item belonging to each of k categories.

In the embodiment of the disclosure, for each to-be-identified item corresponding to each to-be-matched image identification result, the terminal may determine a target category probability from the k probabilities of the to-be-matched item, and determine the candidate category of the to-be-matched item according to the target category probability. For example, the terminal may determine the first z maximum probabilities among the k probabilities, where z is an integer greater than 0, and z may be set according to actual requirements. For example, when z is 3, the terminal may determine the first 3 probabilities as the 3 target category probabilities from the k probabilities of the to-be-matched items corresponding to each to-be-matched image identification result. The 3 categories corresponding to the 3 target category probabilities are used as 3 candidate categories of the to-be-matched item.

In S303, a weighted bipartite graph is constructed for each to-be-matched item, where, the to-be-matched item is taken as a first node and each item element in the item element set of each candidate category is taken as a second node in the weighted bipartite graph, a probability of the candidate category corresponding to each second node is a weight corresponding to an edge connecting the first node to each second node, and the candidate category corresponding to each second node is a category corresponding to an item element set to which the item element represented by each second node belongs.

In the embodiment of the disclosure, the terminal may use each to-be-matched item as the first node, and each item element in a first item element set whose category is the same as a candidate category of the to-be-matched item as the second node, connect the first node to each second node, and take the probability of the candidate category corresponding to the second node as a weight corresponding to the edge that connects the first node to the second node. For example, when a candidate category of a to-be-matched item i is A, a target category probability corresponding to candidate category A is k1, and the first item element set of candidate category A includes three item elements (item element 1, item element 2 and item element 3), the terminal may use the to-be-matched item i as the first node, the item element 1, item element 2, and item element 3 as the three second nodes (second node 1, second node 2, and the second node 3); the first node and the three second nodes are respectively connected to obtain three corresponding edges, while k1 is taken as the weight of each edge. Exemplarily, FIG. 9 is a schematic diagram of exemplary construction of weighted edges between to-be-matched item i and three item elements. Here, after the weighted edge between each to-be-matched item and all item elements corresponding to each candidate category is constructed, a weighted bipartite graph of all to-be-matched items may be obtained.

In S304, maximum bipartite graph matching is performed based on the weighted bipartite graph, to obtain a category of each to-be-matched item as the secondary identification result.

In the embodiment of the disclosure, after obtaining the weighted bipartite graph, the terminal may perform maximum bipartite graph matching based on the weighted bipartite graph, and determine the category of each to-be-matched item according to a matching result, so as to obtain the secondary identification result of each to-be-matched item.

Exemplarily, the terminal may use a bipartite graph maximum-weighted matching algorithm, also known as a KM (Kuhn-Munkras) algorithm, to match the to-be-matched item corresponding to the to-be-matched image identification result with the item elements in the first item element set.

In the embodiment of the disclosure, the terminal determines the category of each to-be-matched item by constructing the bipartite graph and performing the maximum bipartite graph matching on the weighted bipartite graph, thereby improving the accuracy of the determined category of each to-be-matched item.

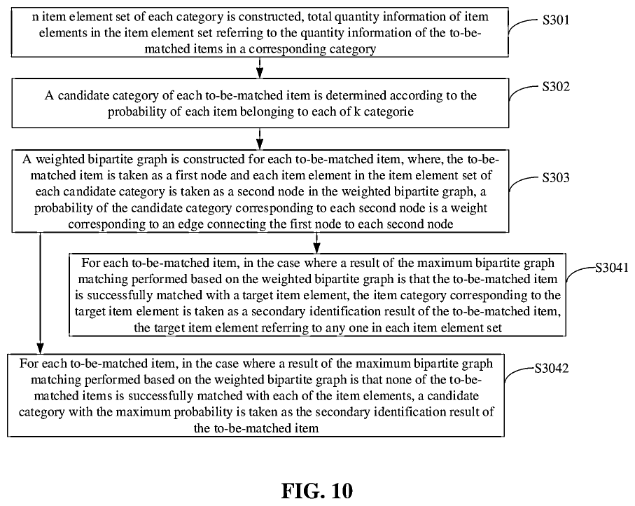

In some embodiments of the disclosure, the above S304 may be implemented through S3041 or S3042, which will be described by taking FIG. 10 as an example.

In S3041, for each to-be-matched item, in the case where a result of the maximum bipartite graph matching performed based on the weighted bipartite graph is that the to-be-matched item is successfully matched with a target item element, the item category corresponding to the target item element is taken as a secondary identification result of the to-be-matched item, the target item element referring to any one in each item element set.

In the embodiments of the present disclosure, when the to-be-matched item corresponding to one to-be-matched image identification result is successfully paired with any item element in all the item element sets, the terminal may take the category corresponding to the item element as the category of the to-be-matched item corresponding to the to-be-matched image identification result, so as to obtain the secondary identification result of the to-be-matched item corresponding to the to-be-matched image identification result.

In S3042, for each to-be-matched item, in the case where a result of the maximum bipartite graph matching performed based on the weighted bipartite graph is that none of the to-be-matched items is successfully matched with each of the item elements, a candidate category with the maximum probability is taken as the secondary identification result of the to-be-matched item.

In the embodiment of the disclosure, when the to-be-matched item corresponding to one to-be-matched image identification result is failed to be matched with any item element in all the first item element sets, the terminal may determine a candidate category with the maximum corresponding probability from all the candidate categories corresponding to the to-be-matched item, and take the candidate category with the maximum probability as the secondary identification result of the to-be-matched item.

In the embodiment of the disclosure, the terminal improves the accuracy of the determined category of each to-be-matched item in this way.

The item identification provided by the disclosure will be described below through applications in an actual scenario.

In S1, an ID of an RFID chip in each game token among each bet of game tokens placed in the game token placement region is read through an RFID antenna in a game token placement region of a game table, to obtain the ID of the RFID chip in each game token.

In S2, the quantity of game tokens of each face value is obtained according to the obtained ID of the RFID chip in each game token and a prestored preset correspondence between IDs and game token face values.

In S3, gesture identification is performed on the acquired image of the bet of game tokens; when the bet of game tokens is in a sideward posture, image identification is performed on the bet of game tokens to identify the position of each game token in the bet of game tokens and the probability of the bet of game tokens belonging to each face value, and a sub-image identification result of each identified game token is obtained in such a way; the total quantity of the bet of game tokens is counted, and the total quantity of the bet of game tokens and the sub-image identification result of each game token that is identified are taken as the image identification result of the bet of game tokens.

In S41, for each identified game token, in the case where the maximum probability corresponding to the game token is greater than the preset confidence threshold, it is determined that the recognition result of the game tokens is correct, and the sub-image recognition result corresponding to the game token is determined to be the matched identification result, so that multiple matched identification results are finally obtained, and the quantity of matched game tokens belonging to each face value among the multiple matched game token corresponding to the multiple matched identification results is determined. A game token corresponding to each matched identification result is a matched game token; each matched identification result includes: the probability of the matched game token belonging to each of k face values and the position of the matched game token in the bet of game tokens, where k is an integer greater than or equal to 1.

In S42, for each identified game token, in the case where the maximum probability corresponding to the game tokens is less than or equal to the preset confidence threshold, the sub-image identification result corresponding to the game token is determined as the to-be-matched identification result, so that multiple to-be-matched identification results are obtained. A game token corresponding to each to-be-matched identification result is a to-be-matched game token; and each to-be-matched identification result includes: the probability of each to-be-matched game token belonging to each of the k face values and the position of the to-be-matched game token in the bet of game tokens.

In S5, for each face value of game tokens, the terminal may subtract the quantity of matched game tokens of the face value obtained in S1 from the quantity of game tokens of the face value obtained in the above S41 to obtain the quantity of game tokens of which the face value is identified in the RFID mode, remained in the game tokens of the face value, and the quantity of remaining game token of which the face value is identified in the RFID mode (the quantity of to-be-matched game tokens in the category).

In S6, in each face value of game tokens obtained in S5, the remaining game tokens of which the face value is identified in the RFID mode is taken as an item element set of the face value in the corresponding type. Each remaining game token of which the face value is identified in the RFID mode serves as one item element in the item element set.

In S7, for the to-be-matched game token corresponding to each to-be-matched identification result, the first 3 probabilities is determined from k probabilities corresponding to the to-be-matched game token, and the face value corresponding to the first three probabilities is taken as a candidate face value (candidate category) of the to-be-matched game token.

In S7, a weighted bipartite graph is constructed for each to-be-matched item, where, the weighted bipartite graph, the to-be-matched game token serves as a first node, each item element in the item element set of each candidate face value serves as a second node, and a probability of the candidate face value corresponding to each second node is a weight corresponding to an edge connecting the first node to each second node.

In S8, the KM algorithm is used to perform maximum bipartite graph matching on the weighted bipartite graph. For each to-be-matched game token, when the result of the maximum bipartite graph matching based on the weighted bipartite graph is that the to-be-matched game token is successfully matched with a target item element, the face value of game tokens corresponding to the target item element is taken as the secondary identification result of the to-be-matched game token, the target item element referring to any one in each first item element set. When the result of the maximum bipartite graph matching based on the weighted bipartite graph is that the to-be-matched item is failed to be matched with each item element, the candidate face value with the maximum probability is used as the secondary identification result of the to-be-matched game token.

In S9, according to the quantity of game tokens of each face value among the bet of game tokens obtained by reading the RFID chip, the face value of each to-be-matched game token obtained by the maximum bipartite graph matching, the face value of the matched game token corresponding to the matched image identification result obtained through image identification, and the position of each game token in the bet of game tokens obtained through image identification, whether the arrangement of the bet of game tokens is valid is determined. When the arrangement of the bet of game tokens is valid, the total face value of the bet of game tokens is determined, is associated with a player who places the bet of game tokens. In addition, the total face value of the game tokens placed by the player is recorded.

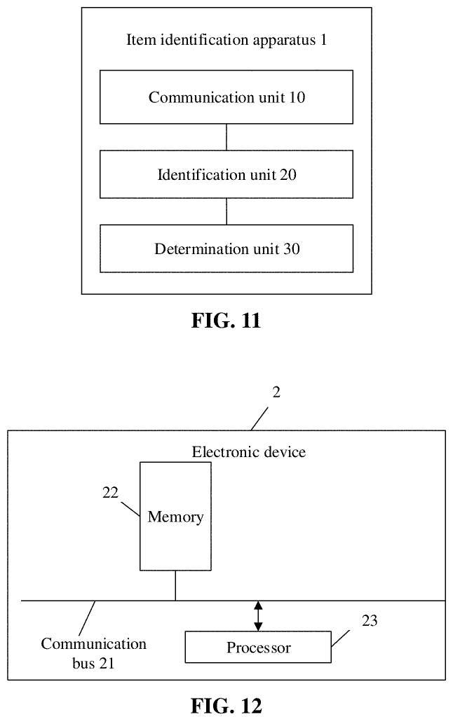

The embodiments of the disclosure further provide an item identification apparatus. FIG. 11 is a structure diagram of an item identification apparatus according to an embodiment of the disclosure. As shown in FIG. 11, the item identification apparatus 1 includes: a communication unit 10, configured to determine categories of items contained in the group of to-be-identified items and quantity information of items in each category contained in the group of to-be-identified items by performing short-range wireless communication with each item in the group of to-be-identified items in a scenario region, each item containing a short-range wireless communication tag corresponding to the category of each item; an identification unit 20, configured to identify acquired images of the group of to-be-identified items to obtain an image identification result of the group of to-be-identified items, the image identification result including a category identification result of each item in the group of to-be-identified items; and a determination unit 30, configured to determine an item identification result of the group of to-be-identified items based on the quantity information and the image identification result.

In some embodiments of the disclosure, the communication unit 10 is further configured to: perform, with a first communication component pre-erected in the scenario region, short-range wireless communication with a second communication component of each to-be-identified item in the group of to-be-identified items in the scenario region to obtain an item identifier stored in the second communication component of each item; and determine, based on the item identifier and a prestored preset correspondence between item identifiers and item categories, the categories of the items contained in the group of to-be-identified and the quantity information of the items in each category contained in the group of to-be-identified items.

In some embodiments of the disclosure, the determination unit 30 is further configured to: determine a to-be-matched image identification result and a matched image identification result from the image identification result of the group of to-be-identified items based on the image identification result and a preset confidence threshold,; determine quantity information of matched items of the items in each category according to the matched image identification result; determine quantity information of to-be-matched items in each category based on the quantity information of the matched items and the quantity information of the items in each category; perform matching check according to the quantity information of the to-be-matched items in each category and the to-be-matched image identification result, to determine a secondary identification result; and determine the item identification result according to the matched image identification result and the secondary identification result.

In some embodiments of the disclosure, the category identification result of each item may include a probability of each item belonging to each of k categories, k being an integer greater than or equal to 1; the matched image identification result includes the category identification result of matched items in the group of to-be-identified items, the matched items including an item with a maximum probability, among k probabilities, greater than the preset confidence threshold; and the to-be-matched image identification result includes the category identification result of to-be-matched items in the group of to-be-identified items, the to-be-matched items including an item with a maximum probability, among k probabilities, less than the preset confidence threshold.

In some embodiments of the disclosure, the determination unit 20 is further configured to: construct an item element set of each category, total quantity information of item elements in the item element set referring to the quantity information of the to-be-matched items in a corresponding category; determine a candidate category of each to-be-matched item according to the probability of each item belonging to each of k categories; construct a weighted bipartite graph for each to-be-matched item, where the to-be-matched item is taken as a first node and each item element in the item element set of each candidate category is taken as a second node in the weighted bipartite graph, a probability of the candidate category corresponding to each first node is a weight corresponding to an edge connecting the first node to each second node, and the candidate category corresponding to each second node is a category corresponding to an item element set to which the item element represented by each second node belongs; and perform maximum bipartite graph matching based on the weighted bipartite graph, to obtain a category of each to-be-matched item as the secondary identification result.

In some embodiments of the disclosure, the determination unit 30 is further configured to, for each to-be-matched item, in the case where a result of the maximum bipartite graph matching performed based on the weighted bipartite graph is that none of the to-be-matched items is successfully matched with each of the item elements, take a candidate category with the maximum probability of the to-be-matched item as the secondary identification result of the to-be-matched item.

In some embodiments of the disclosure, the determination unit 30 is further configured to fuse the category identification result of the matched items in the matched image identification result with the secondary identification result of the to-be-matched items to obtain the item identification result.

The embodiments of the disclosure further provide an electronic device. FIG. 12 is a structure diagram of an electronic device according to an embodiment of the disclosure. As shown in FIG. 12, the electronic device 2 includes a memory 22 and a processor 23. The memory 22 and the processor 23 are connected through a communication bus 21. The memory 22 is configured to store an executable computer program. When executing the executable computer program stored in the memory, the processor 23 is configured to implement the method according to the embodiments of the disclosure, for example, the item identification method according to the embodiments of the disclosure.

The embodiments of the disclosure provide a computer-readable storage medium, storing a computer program. The computer program is executed by a processor 23 to implement the method provided by the embodiments of the disclosure, for example, the object identification method provided by the embodiments of the disclosure.

In some embodiments of the disclosure, the storage medium may be FRAM, ROM, PROM, EPROM, EEPROM, flash memory, magnetic surface memory, optical disk, CD-ROM and other memories, and may also be various devices including one or any combination of the above memories.

In some embodiments, the executable instruction may be compiled according to a programming language of any form (including a compiling or interpretive language, or a declarative or procedural language) in form of a program, software, a software module, a script, or a code, and may be deployed according to any form, including deployed as an independent program or deployed as a module, a component, a subroutine or another unit suitable to be used in a computing environment.

As an example, the executable instruction may but not always correspond to a file in a file system, and may be stored in a part of a file that stores another program or data, for example, stored in one or more scripts in a Hyper Text Markup Language (HTML) document, stored in a single file dedicated to a discussed program, or stored in multiple collaborative files (for example, files storing one or more modules, subprograms or code parts).

As an example, the executable instruction may be deployed in a computing device for execution, or executed in multiple computing devices at the same place, or executed in multiple computing devices that are interconnected through a communication network at multiple places.

In summary, since the final item identification result is determined by a combination of the image identification result and the short-range wireless communication identification, the identification result obtained finally is more accurate and comprehensive and covers more information as compared with the image identification result or the short-range wireless communication identification result, so that the accuracy and coverage of the identification result are improved. Moreover, the scenario status recorded based on the accurate and comprehensive identification result is more accurate and more comprehensive.

The above is only the embodiment of the disclosure and not intended to limit the scope of protection of the disclosure. Any modifications, equivalent replacements, improvements and the like made within the spirit and scope of the disclosure fall within the scope of protection of the disclosure.

What is claimed is:

1. An item identification method, comprising:
determining categories of items contained in a group of to-be-identified items and quantity information of items in each category contained in the group of to-be-identified items by performing short-range wireless communication with each item in the group of to-be-identified items in a scenario region, each item containing a short-range wireless communication tag corresponding to a category of each item;
identifying acquired images of the group of to-be-identified items to obtain an image identification result of the group of to-be-identified items, the image identification result comprising a category identification result of each item in the group of to-be-identified items; and
determining an item identification result of the group of to-be-identified items based on the quantity information and the image identification result.

2. The method of claim 1, wherein the determining categories of items contained in a group of to-be-identified items and quantity information of items in each category contained in the group of to-be-identified items by performing short-range wireless communication with each item in the group of to-be-identified items in a scenario region comprises:
performing, with a first communication component pre-erected in the scenario region, short-range wireless communication with a second communication component of each to-be-identified item in the group of to-be-identified items in the scenario region to obtain an item identifier stored in the second communication component of each item; and
determining, based on the item identifier and a prestored preset correspondence between item identifiers and item categories, the categories of the items contained in the group of to-be-identified items and the quantity information of the items in each category contained in the group of to-be-identified items.

3. The method of claim 1, wherein the determining an item identification result of the group of to-be-identified items based on the quantity information and the image identification result comprises:
determining a to-be-matched image identification result and a matched image identification result from the image identification result of the group of to-be-identified items based on the image identification result and a preset confidence threshold;
determining quantity information of matched items of the items in each category according to the matched image identification result;
determining quantity information of to-be-matched items in each category based on the quantity information of the matched items and the quantity information of the items in each category;
performing matching check according to the quantity information of the to-be-matched items in each category and the to-be-matched image identification result, to determine a secondary identification result; and
determining the item identification result according to the matched image identification result and the secondary identification result.

4. The method of claim 3, wherein the category identification result of each item comprises a probability of each item belonging to each of k categories, k being an integer greater than or equal to 1;
wherein the matched image identification result comprises the category identification result of matched items in the group of to-be-identified items, the matched items comprising an item with a maximum probability, among k probabilities, greater than the preset confidence threshold;
wherein the to-be-matched image identification result comprises the category identification result of to-be-matched items in the group of to-be-identified items, the to-be-matched items comprising an item with a maximum probability, among the k probabilities, less than the preset confidence threshold.

5. The method of claim 4, wherein the performing matching check according to the quantity information of the to-be-matched items in each category and the to-be-matched image identification result, to determine a secondary identification result comprises:
constructing an item element set of each category, total quantity information of item elements in the item element set referring to quantity information of the to-be-matched items in a corresponding category;
determining a candidate category of each to-be-matched item according to the probability of each item belonging to each of k categories;
constructing a weighted bipartite graph for each to-be-matched item, wherein the to-be-matched item is taken as a first node and each item element in the item element set of each candidate category is taken as a second node in the weighted bipartite graph, a probability of the candidate category corresponding to each second node is a weight corresponding to an edge connecting the first node to each second node, and the candidate category corresponding to each second node is a category corresponding to an item element set to which the item element represented by each second node belongs; and
performing maximum bipartite graph matching based on the weighted bipartite graph, to obtain a category of each to-be-matched item as the secondary identification result.

6. The method of claim 5, wherein the performing matching check according to the quantity information of the to-be-matched items in each category and the to-be-matched image identification result, to determine a secondary identification result further comprises:
for each to-be-matched item, in a case where a result of the maximum bipartite graph matching performed based on the weighted bipartite graph is that none of the to-be-matched items is successfully matched with each of the item elements, taking the candidate category with a maximum probability of the to-be-matched item as the secondary identification result of the to-be-matched item.

7. The method of claim 4, wherein the determining the item identification result according to the matched image identification result and the secondary identification result comprises:
fusing the category identification result of the matched items in the matched image identification result with the secondary identification result of the to-be-matched items to obtain the item identification result.

8. An electronic device, comprising a memory and a processor,
wherein the memory is configured to store an executable computer program;
wherein when executing the executable computer program stored in the memory, the processor is configured to:
determine categories of items contained in a group of to-be-identified items and quantity information of items in each category contained in the group of to-be-identified items by performing short-range wireless communication with each item in the group of to-be-identified items in a scenario region, each item containing a short-range wireless communication tag corresponding to a category of each item;
identify acquired images of the group of to-be-identified items to obtain an image identification result of the group of to-be-identified items, the image identification result comprising a category identification result of each item in the group of to-be-identified items; and
determine an item identification result of the group of to-be-identified items based on the quantity information and the image identification result.

9. The electronic device of claim 8, wherein when determining the categories of the items contained in the group of to-be-identified items and the quantity information of the items in each category contained in the group of to-be-identified items by performing short-range wireless communication with each item in the group of to-be-identified items in the scenario region, the processor is configured to:
perform, with a first communication component pre-erected in the scenario region, short-range wireless communication with a second communication component of each to-be-identified item in the group of to-be-identified items in the scenario region to obtain an item identifier stored in the second communication component of each item; and
determine, based on the item identifier and a prestored preset correspondence between item identifiers and item categories, the categories of the items contained in the group of to-be-identified items and the quantity information of the items in each category contained in the group of to-be-identified items.

10. The electronic device of claim 8, wherein when determining the item identification result of the group of to-be-identified items based on the quantity information and the image identification result, the processor is configured to:
determine a to-be-matched image identification result and a matched image identification result from the image identification result of the group of to-be-identified items based on the image identification result and a preset confidence threshold;
determine quantity information of matched items of the items in each category according to the matched image identification result;
determine quantity information of to-be-matched items in each category based on the quantity information of the matched items and the quantity information of the items in each category;
perform matching check according to the quantity information of the to-be-matched items in each category and the to-be-matched image identification result, to determine a secondary identification result; and
determine the item identification result according to the matched image identification result and the secondary identification result.

11. The electronic device of claim 10, wherein the category identification result of each item comprises a probability of each item belonging to each of k categories, k being an integer greater than or equal to 1;
wherein the matched image identification result comprises the category identification result of matched items in the group of to-be-identified items, the matched items comprising an item with a maximum probability, among k probabilities, greater than the preset confidence threshold;
wherein the to-be-matched image identification result comprises the category identification result of to-be-matched items in the group of to-be-identified items, the to-be-matched items comprising an item with a maximum probability, among the k probabilities, less than the preset confidence threshold.

12. The electronic device of claim 11, wherein when performing the matching check according to the quantity information of the to-be-matched items in each category and the to-be-matched image identification result, to determine a secondary identification result, the processor is configured to:
construct an item element set of each category, total quantity information of item elements in the item element set referring to quantity information of the to-be-matched items in a corresponding category;
determine a candidate category of each to-be-matched item according to the probability of each item belonging to each of k categories;
construct a weighted bipartite graph for each to-be-matched item, wherein the to-be-matched item is taken as a first node and each item element in the item element set of each candidate category is taken as a second node in the weighted bipartite graph, a probability of the candidate category corresponding to each second node is a weight corresponding to an edge connecting the first node to each second node, and the candidate category corresponding to each second node is a category corresponding to an item element set to which the item element represented by each second node belongs; and
perform maximum bipartite graph matching based on the weighted bipartite graph, to obtain a category of each to-be-matched item as the secondary identification result.

13. The electronic device of claim 12, wherein when performing the matching check according to the quantity information of the to-be-matched items in each category and the to-be-matched image identification result, to determine a secondary identification result, the processor is further configured to:
for each to-be-matched item, in a case where a result of the maximum bipartite graph matching performed based on the weighted bipartite graph is that none of the to-be-matched items is successfully matched with each of the item elements, take the candidate category with a maximum probability of the to-be-matched item as the secondary identification result of the to-be-matched item.

14. The electronic device of claim 11, wherein when determining the item identification result according to the matched image identification result and the secondary identification result, the processor is configured to:
fuse the category identification result of the matched items in the matched image identification result with the secondary identification result of the to-be-matched items to obtain the item identification result.

15. A nonvolatile computer-readable storage medium, having a computer program stored thereon, wherein the computer program, when executed by a processor, is configured to:
determine categories of items contained in a group of to-be-identified items and quantity information of items in each category contained in the group of to-be-identified items by performing short-range wireless communication with each item in the group of to-be-identified items in a scenario region, each item containing a short-range wireless communication tag corresponding to a category of each item;
identify acquired images of the group of to-be-identified items to obtain an image identification result of the group of to-be-identified items, the image identification result comprising a category identification result of each item in the group of to-be-identified items; and
determine an item identification result of the group of to-be-identified items based on the quantity information and the image identification result.

16. The nonvolatile computer-readable storage medium of claim 15, wherein when determining the categories of the items contained in the group of to-be-identified items and the quantity information of the items in each category contained in the group of to-be-identified items by performing short-range wireless communication with each item in the group of to-be-identified items in the scenario region, the computer program is configured to:
perform, with a first communication component pre-erected in the scenario region, short-range wireless communication with a second communication component of each to-be-identified item in the group of to-be-identified items in the scenario region to obtain an item identifier stored in the second communication component of each item; and
determine, based on the item identifier and a prestored preset correspondence between item identifiers and item categories, the categories of the items contained in the group of to-be-identified items and the quantity information of the items in each category contained in the group of to-be-identified items.

17. The nonvolatile computer-readable storage medium of claim 15, wherein when determining the item identification result of the group of to-be-identified items based on the quantity information and the image identification result, the computer program is configured to:
determine a to-be-matched image identification result and a matched image identification result from the image identification result of the group of to-be-identified items based on the image identification result and a preset confidence threshold;
determine quantity information of matched items of the items in each category according to the matched image identification result;
determine quantity information of to-be-matched items in each category based on the quantity information of the matched items and the quantity information of the items in each category;
perform matching check according to the quantity information of the to-be-matched items in each category and the to-be-matched image identification result, to determine a secondary identification result; and
determine the item identification result according to the matched image identification result and the secondary identification result.

18. The nonvolatile computer-readable storage medium of claim 17, wherein the category identification result of each item comprises a probability of each item belonging to each of k categories, k being an integer greater than or equal to 1;
wherein the matched image identification result comprises the category identification result of matched items in the group of to-be-identified items, the matched items comprising an item with a maximum probability, among k probabilities, greater than the preset confidence threshold;
wherein the to-be-matched image identification result comprises the category identification result of to-be-matched items in the group of to-be-identified items, the to-be-matched items comprising an item with a maximum probability, among the k probabilities, less than the preset confidence threshold.

19. The nonvolatile computer-readable storage medium of claim 18, wherein when performing the matching check according to the quantity information of the to-be-matched items in each category and the to-be-matched image identification result, to determine a secondary identification result, the computer program is configured to:
construct an item element set of each category, total quantity information of item elements in the item element set referring to quantity information of the to-be-matched items in a corresponding category;
determine a candidate category of each to-be-matched item according to the probability of each item belonging to each of k categories;
construct a weighted bipartite graph for each to-be-matched item, wherein the to-be-matched item is taken as a first node and each item element in the item element set of each candidate category is taken as a second node in the weighted bipartite graph, a probability of the candidate category corresponding to each second node is a weight corresponding to an edge connecting the first node to each second node, and the candidate category corresponding to each second node is a category corresponding to an item element set to which the item element represented by each second node belongs; and
perform maximum bipartite graph matching based on the weighted bipartite graph, to obtain a category of each to-be-matched item as the secondary identification result.

20. The nonvolatile computer-readable storage medium of claim 19, wherein when performing the matching check according to the quantity information of the to-be-matched items in each category and the to-be-matched image identification result, to determine a secondary identification result, the computer program is further configured to:
for each to-be-matched item, in a case where a result of the maximum bipartite graph matching performed based on the weighted bipartite graph is that none of the to-be-matched items is successfully matched with each of the item elements, take the candidate category with a maximum probability of the to-be-matched item as the secondary identification result of the to-be-matched item.
